(19) United States
(12) Patent Application Publication
(10) Pub. No.: US 2011/0261033 A1
(43) Pub. Date: Oct. 27, 2011

(54) PROJECTION DISPLAY DEVICE

(75) Inventors: Shinya MATSUMOTO, Uji-City (JP); Yusuke ITO, Toyonaka-City (JP)

(73) Assignee: SANYO ELECTRIC CO., LTD., Moriguchi-shi (JP)

(21) Appl. No.: 13/087,513

(22) Filed: Apr. 15, 2011

(30) Foreign Application Priority Data
Apr. 22, 2010 (JP) 2010-099192

(51) Int. Cl. G09G 5/00

(52) U.S. Cl. 345/204

(57) ABSTRACT

A projection display device includes a light source, an imager which modulates light from the light source, a light-guiding optical part which guides the light from the light source to the imager, a projection optical part which enlarges and projects the light modulated by the imager, a light source drive part which drives the light source by pulse modulation, an imager drive part which drives the imager, and an output part which outputs a drive signal generated by the imager drive part to the imager. The output part is disposed in a first section within a main body cabinet, and the light source drive part is disposed in a second section arranged diagonally to the first section.

This application claims priority under 35 U.S.C. Section 119 of Japanese Patent Application No. 2010-099192 filed Apr. 22, 2010, entitled “PROJECTION DISPLAY DEVICE”. The disclosure of the above application is incorporated herein by reference.

### BACKGROUND OF THE INVENTION

1. Field of the Invention

The present invention relates to projection display devices that enlarge and project light modulated by an imager.

2. Disclosure of Related Art

Conventionally, there are known projection display devices (hereinafter, referred to as “projectors”) that modulate light from light sources by an imager and generate the thus generated light (hereinafter, referred to as “image light”) onto a projection plane.

In this type of a projector, the imager may use a digital Micro-mirror Device (DMD), for example. The DMD is configured to have a large number of micro-mirrors disposed on a plane. When these micro-mirrors are driven to turn on and off in accordance with image signals and are switched in inclination angle, light from the light sources is modulated. The light sources may be LED light sources, for example.

In such a projector, it is conceived that high-power LED light sources are used to provide image (s) with high brightness. In this case, to achieve high brightness efficiently with power consumption suppressed, the LED light sources are desirably driven using a drive circuit according to pulse modulation methods. The pulse modulation methods include Pulse Width Modulation (PWM) and Pulse Amplitude Modulation (PAM), for example.

If high-power LED light sources are driven by pulse modulation (PWM or PAM), modulation is carried out with relatively high electric current values. This causes easily generation of noise due to electromagnetic field (hereinafter, referred to as “EMI noise”) at a drive circuit for the LED light sources (in particular, connection with cables) and cables connecting the drive circuit and the LED light sources.

The imager receives drive signals for micro-mirrors output from a corresponding drive circuit, that is, signals for turning on and off the micro-mirrors at a high speed. If any EMI noise is superimposed on drive signals for the imager, the micro-mirrors may not be driven properly, thereby to cause an error in gradation of image (s) to be projected and bring about deterioration in image quality.

### SUMMARY OF THE INVENTION

A projection display device in a main aspect of the present invention includes a light source, an imager which modulates light from the light source, a light-guiding optical part which guides the light from the light source to the imager, a projection optical part which enlarges and projects the light modulated by the imager, a light source drive part which drives the light source by pulse modulation, an imager drive part which drives the imager, and an output part which outputs a drive signal generated by the imager drive part to the imager. The output part is disposed in a first section within a main body cabinet, and the light source drive part is disposed in a second section arranged diagonally to the first section.

According to the projection display device in the main aspect of the present invention, the output part which outputs a drive signal to the imager is disposed as distant from the light source drive part as possible.

### BRIEF DESCRIPTION OF THE DRAWINGS

The foregoing and other objects and novel features of the present invention will be more fully understood from the following description of a preferred embodiment when reference is made to the accompanying drawings.

FIG. 1 is a diagram showing an outer configuration of a projector in an embodiment of the present invention.

FIG. 2 is a diagram showing an inner configuration of the projector in the embodiment.

FIG. 3 is a diagram showing an inner configuration of the projector in the embodiment.

FIG. 4 is a block diagram showing a configuration of the projector in the embodiment.

FIG. 5 is a diagram showing light-emission characteristics of a red light source, a green light source, and a blue light source in the embodiment.

FIG. 6 is a diagram showing a configuration of a projector in a modified example 1.

FIGS. 7A to 7C are diagrams for describing a configuration of a light source system and a light-guiding optical system in a modification example 2.

However, the drawings are intended only for illustration and do not limit the scope of the present invention.

### DESCRIPTION OF PREFERRED EMBODIMENTS

Preferred embodiment of the present invention will be described below with reference to the drawings.

In this embodiment, a red light source 201R, a green light source 201G, and a blue light source 201B are equivalent to a “light source” recited in the claims. A light-guiding optical system 30 is equivalent to a “light-guiding optical part” recited in the claims. A DMD 40 is equivalent to an “imager” recited in the claims. A projection optical unit 50 is equivalent to a “projection optical part” recited in the claims. A DMD drive circuit 603 is equivalent to an “imager drive part” recited in the claims. An output terminal part 604 is equivalent to an “output part” recited in the claims. An LED drive circuit 70 is equivalent to a “light source drive part” recited in the claims. An electromagnetic shield part 80 is equivalent to a “shield part” recited in the claims. The foregoing correspondences in description between the claims and this embodiment are merely examples, and are not intended to limit the claims by this embodiment.

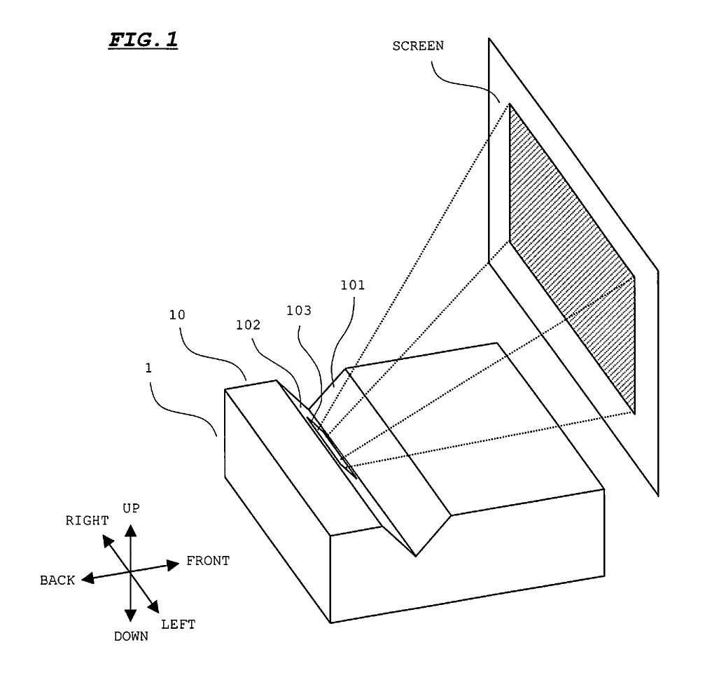

FIG. 1 is a diagram showing an outer configuration of a projector 1 in this embodiment. In this embodiment, for the sake of convenience, a side on which a screen is located as seen from the projector 1 is defined as front, a side opposite to the screen is defined as back, a right side on which the projector 1 is located as seen from the screen is defined as right, and a left side on which the projector 1 is located as seen from the screen is defined as left, a side vertical to the front, back, right, and left sides and on which the screen is located as seen from the projector 1 is defined as upper, and a side opposite to the upper side is defined as lower.

The projector in this embodiment is a so-called short focus projector 1. The projector 1 includes an approximately square main body cabinet 10. The main body cabinet 10 has, on an upper surface, a first slant plane 101 descending backward and a second slant plane 102 ascending backward subsequent from the first slant plane 101. The second slant plane 102 is oriented obliquely upward and forward, and has a projection opening 103 formed thereon. Image light is emitted obliquely upward and forward through the projection opening 103 and is enlarged and projected onto the screen arranged in front of the projector.

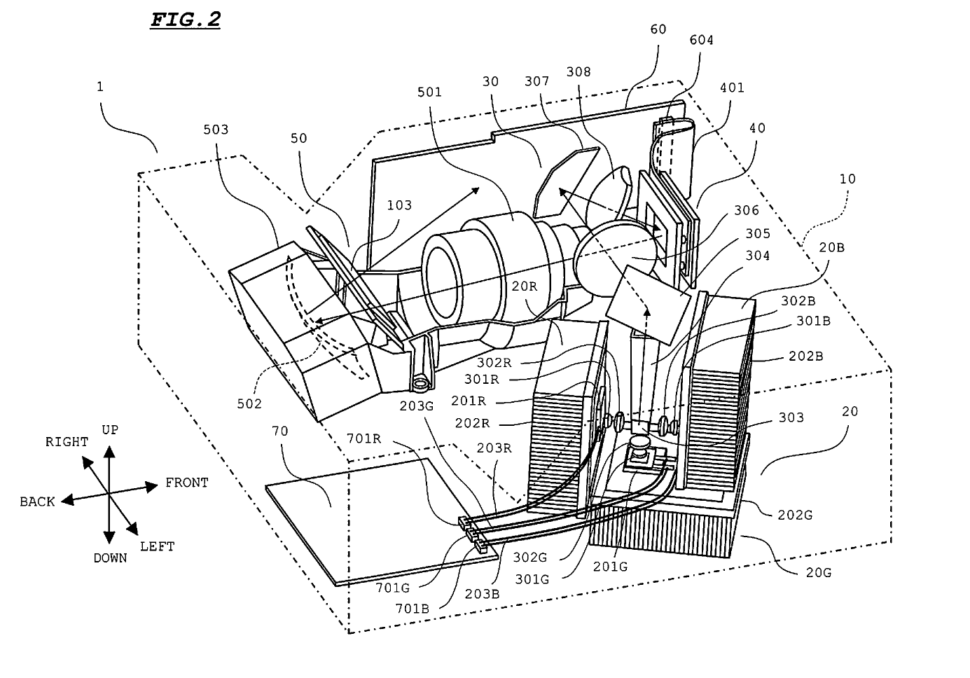

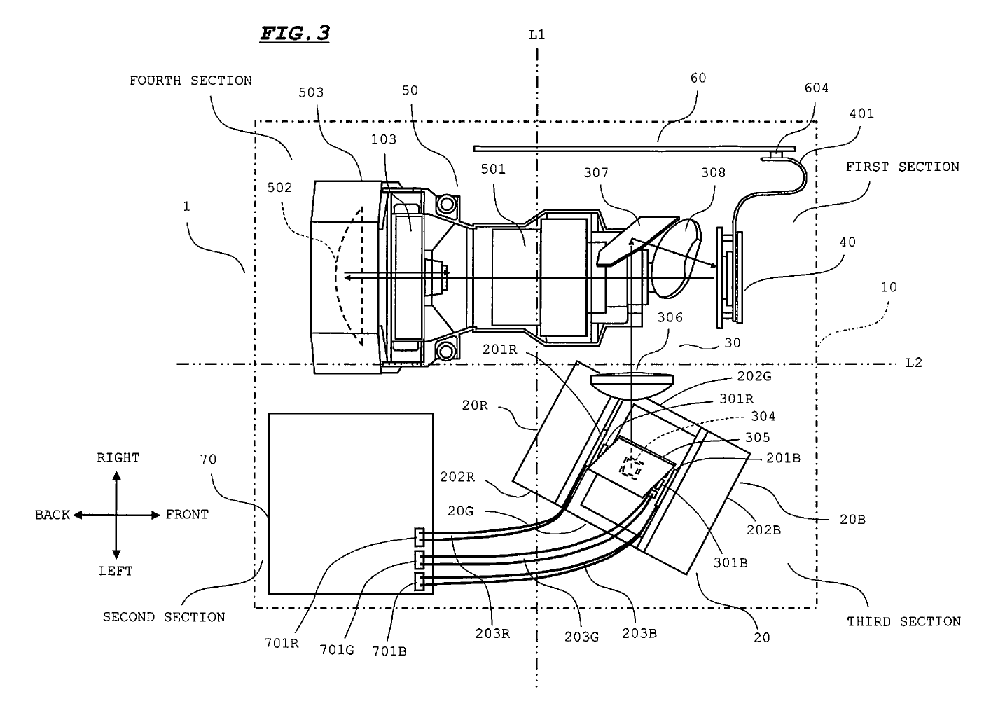

FIGS. 2 and 3 are diagrams showing an inner configuration of the projector in this embodiment: FIG. 2 is a perspective view of the projector; and FIG. 3 is a plan view of the projector. For the convenience, FIGS. 2 and 3 show the main body cabinet 10 by one-dotted chain line.

As shown in FIG. 3, an inside of the main body cabinet 10 can be divided into four sections as seen from above by two dot-chain lines L1 and L2. Hereinafter, assumption is made that a right front section is defined as a first section, a section disposed diagonally to the first section is defined as a second section, a left front section is defined as a third section, and a section disposed diagonally to the third section is defined as a fourth section.

Referring to FIGS. 2 and 3, the main body cabinet 10 has therein a light source system 20, a light-guiding optical system 30, a DMD 40, a projection optical unit 50, a control circuit 60, and an LED drive circuit 70.

The light source system 20 has three light source units 20R, 20G, and 20B. The red light source unit 20R is constituted by a red light source 201R emitting light of red wavelength band (hereinafter, referred to as “R light”) and a heat sink 202R for releasing heat generated at the red light source 201R. The green light source unit 20G is constituted by a green light source 201G emitting light of green wavelength band (hereinafter, referred to as “G light”) and a heat sink 202G for releasing heat generated at the green light source 201G. The blue light source unit 20B is constituted by a blue light source 201B emitting light of blue wavelength band (hereinafter, referred to as “B light”) and a heat sink 202B for releasing heat generated at the blue light source 201B.

The light sources 201R, 201G, and 201B are high-power LED light sources, which are constituted by LEDs (red LED, green LED, and blue LED) arranged on the substrate. The red LED is formed by aluminum indium gallium phosphide (AlGaInP), for example, and the green LED and the blue LED are formed by gallium nitride (GaN), for example.

The light-guiding optical system 30 is formed by: first lenses 301R, 301G, and 301B and second lenses 302R, 302G, and 302B, which are arranged in correspondence with the light sources 201R, 201G, and 201B; a dichroic prism 303; a hollow rod integrator (hereinafter, abbreviated as hollow rod) 304; two mirrors 305 and 307; and two relay lenses 306 and 308.

R light, G light, and B light emitted from the light sources 201R, 201G, and 201B, respectively, are converted to parallel lights by the first lenses 301R, 301G, and 301B and the second lenses 302R, 302G, and 302B, and light paths thereof are combined by the dichroic prism 303.

The lights emitted from the dichroic prism 303 (R light, B light, and G light) enter the hollow rod 304. The hollow rod 304 is hollow inside and has mirror planes on inner surfaces thereof. The hollow rod 304 is tapered so as to become larger in cross-section area from an incident end surface to an output end surface. On the hollow rod 304, the lights are repeatedly reflected by the mirror planes to be unified in illuminance distribution on the output end surface.

The hollow rod 304 has a smaller refractive index as compared with a solid rod integrator (refractive index of air<refractive index of glass), and therefore use of the hollow rod 304 makes it possible to shorten a rod length.

The lights emitted from the hollow rod 304 is irradiated onto the DMD 40 by reflection on the mirrors 305 and 307 and by lens function of the relay lenses 306 and 308.

The DMD 40 has a plurality of micro-mirrors arranged in a matrix. One micro-mirror constitutes one pixel. The micro-mirrors are driven so as to turn on and off at a high speed, on the basis of DMD drive signals corresponding to the incident R light, G light, and B light.

By switching incident angles of the micro-mirrors, the lights from the light sources 201R, 201G, and 201B (R light, G light, and B light) are modulated. Specifically, if any micro-mirror for one pixel is turned off, light reflected by the micro-mirror does not enter the lens unit 501. On the other hand, if the micro-mirror is turned on, light reflected by the micro-mirror enters the lens unit 501. By regulating proportions of times during which the micro-mirrors are on, it is possible to adjust gradation of an image for each pixel.

The projection optical unit 50 is constituted by the lens unit 501, a curved mirror 502, and a housing 503 for storing the two.

Lights (image lights) modulated by the DMD 40 pass through the lens unit 501, and are emitted to the curved mirror 502. The image lights are reflected by the curved mirror 502, and are emitted outward through the projection opening 103 in the housing 503.

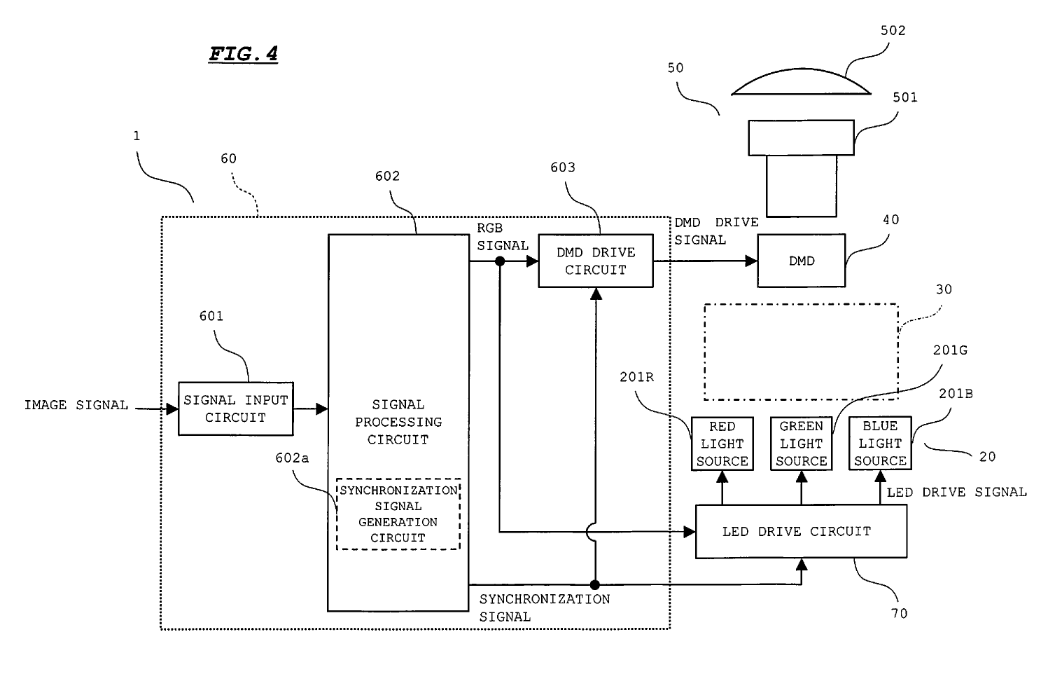

FIG. 4 is a block diagram showing a configuration of the projector in this embodiment.

Referring to FIG. 4, the control circuit 60 includes a signal input circuit 601, a signal processing circuit 602, and a DMD drive circuit 603.

The signal input circuit 601 outputs image signals received via various input terminals corresponding to various image signals such as composite signals, RGB signals, and the like, to the signal processing circuit 602.

The signal processing circuit 602 performs various correction processes such as a conversion process of converting image signals other than RGB signals into RGB signals, a scaling process of converting resolutions of the input image signals into resolutions suited to the DMD 40, and a gamma correction process. Then, the signal processing circuit 602 outputs these processed RGB signals to the DMD drive circuit 603 and the LED drive circuit 70.

The signal processing circuit 602 includes a synchronization signal generation circuit 602a. The synchronization signal generation circuit 602a generates a synchronization signal for providing synchronization between driving the light sources 201R, 201G, and 201B and driving the DMD 40. The generated synchronization signal is output into the DMD drive circuit 603 and the LED drive circuit 70.

The DMD drive circuit 603 generates DMD drive signals (on-off signals) corresponding to R light, G light, and B light, in accordance with the RGB signals from the signal processing circuit 602. Then, the DMD drive circuit 603 outputs sequentially the generated DMD drive signals corresponding to the lights for each one-frame image to the DMD 40 in a time-division manner, according to the synchronization signal.

The LED drive circuit 70 drives the light sources 201R, 201G, and 201B, in accordance with RGB signals from the signal processing circuit 602. Specifically, the LED drive circuit 70 generates LED drive signals by pulse width modulation (PWM), and outputs the LED drive signals (drive currents) to the light sources 201R, 201G, and 201B.

That is, the LED drive circuit 70 regulates amounts of light output from the light sources 201R, 201G, and 201B by adjusting a duty ratio of pulse waves in accordance with the RGB signals. Accordingly, the amounts of lights output from the light sources 201R, 201G, and 201B are adjusted in accordance with image color information for each one-frame image.

The LED drive circuit 70 also outputs LED drive signals to the light sources 201R, 201G, and 201B in accordance with the synchronization signal. Accordingly, it is possible to synchronize light-emission timings for lights to be emitted from the light sources 201R, 201G, and 201B (R light, G light, and B light) and output timings of DMD drive signals to the DMD 40 in correspondence with the respective lights.

Specifically, in a period of time during which a DMD drive signal corresponding to the R light is output, the red light source 201R emits an amount of R light suited to the image color information at that time. Similarly, in a period of time during which a DMD drive signal corresponding to the G light is output, the green light source 201G emits an amount of G light suited to image color information at that time. Further, in a period of time during which a DMD drive signal corresponding to B light is output, the blue light source 201B emits an amount of B light suited to image color information at that time.

By changing amounts of lights emitted from the light sources 201R, 201G, and 201B in accordance with image color information, it is possible to provide high-brightness projection images with power consumption suppressed.

Images formed by the R light, G light, and B light are projected in sequence onto the screen. However, since switching between these images takes place at an extremely high speed, these images are seen as flicker-free color images to the eyes of a user.

Returning to FIGS. 2 and 3, the light source units 20R, 20G, and 20B, the light-guiding optical system 30, the DMD 40, the projection optical unit 50, the control circuit 60, and the LED drive circuit 70, are disposed on a bottom surface of the main body cabinet 10 as a placement plane.

The projection optical unit 50 is disposed on a right side of the main body cabinet 10, in a section ranging from an almost center to a back portion in a front-back direction (the fourth section). In this disposition, the lens unit 501 is almost centered and the curved mirror 502 is positioned in the back portion.

The DMD 40 is disposed in front of the lens unit 501. Specifically, the DMD 40 is disposed on the right side of the main body cabinet 10, in a section near the front surface (the first section).

The light source system 20 is disposed on the left side of the lens unit 501 and the DMD 40 (the third section). The three light source units 20R, 20G, and 20B are positioned in such a manner that the red light source 201R and the blue light source 201B are disposed above the green light source 201G and are opposed to each other with the green light source 201G therebetween.

In the projection optical unit 50, the curved mirror 502 is disposed close to the bottom surface of the main body cabinet 10 (a lower portion of the fourth section), the lens unit 501 is disposed in a position slightly higher than the curved mirror (a middle-height portion of the fourth section). In addition, the DMD 40 is disposed in a position away from the bottom surface of the main body cabinet 10 (an upper portion of the first section), and the three light sources 201R, 201G, and 201B are disposed in positions close to the bottom surface of the main body cabinet 10 (a lower portion of the third section). Accordingly, the light-guiding optical system 30 has constituent elements aligned ranging from the positions of the three light sources 201R, 201G, and 201B to the forward position of the DMD 40. Therefore, the light-guiding optical system 30 is two-fold at a right angle as seen from the front side of the projector.

That is, the first lenses 301R, 301G, and 301B, the second lenses 302R, 302G, and 302B, and the dichroic prism 303 are disposed within a section surrounded by the three light sources 201R, 201G, and 201B. The hollow rod 304 is disposed above the dichroic prism 303 along an up-down direction. In addition, ranging from above the hollow rod 304 to the lens unit 501, the mirror 305, the relay lens 306, and the mirror 307 are disposed in sequence, and the relay lens 308 is disposed between the mirror 307 and the DMD 40.

In this manner as described above, the light-guiding optical system 30 has a light path in which lights from the light sources 201R, 201G, and 201B are guided upward by the hollow rod 304 and are bent toward the lens unit 501. This makes it possible to shorten the light-guiding optical system 30 in a right-left direction, thereby reducing an area of the bottom surface of the main body cabinet 10. Accordingly, the projector can be made compact.

The control circuit 60 is disposed near the right side surface of the main body cabinet 10 ranging from the almost center to the front end in the front-back direction. The control circuit 60 is formed by a substrate on which a predetermined pattern wiring is formed and various electronic component mounted on the substrate. The control circuit 60 is disposed within the main body cabinet 10 in such a manner that the substrate plane is aligned with the right side surface of the main body cabinet 10.

An output terminal part 604 is provided at a front end of the control circuit 60 at a front right corner (an endmost portion of the first section) of the main body cabinet 10. The output terminal part 604 receives DMD drive signals generated by the DMD drive circuit 603. The output terminal part 604 is formed by a connector, for example. The output terminal part 604 is connected to a cable 401 extending from the DMD 40. The output terminal part 604 sends the DMD drive signals through the cable 401 to the DMD 40.

The LED drive circuit 70 is disposed at a left back corner (the second section) of the main body cabinet 10. The LED drive circuit 70 is formed by a substrate on which a predetermined pattern wiring is formed and various electric components implemented on the substrate.

Three output terminal parts 701R, 701G, and 701B are provided in front (at a front end) of the LED drive circuit 70. The output terminal parts 701R, 701G, and 701B are connected to cables 203R, 203G, and 203B extending from the corresponding light sources 201R, 201G, and 201B, respectively. The output terminal parts 701R, 701G, and 701B send LED drive signals (drive currents) through these cables 203R, 203G, and 203B to the light sources 201R, 201G, and 201B.

Among the three light sources 201R, 201G, and 201B, the red light source 201R is disposed nearest the LED drive circuit. Accordingly, among the three cables 203R, 203G, and 203B, the cable 203R corresponding to the red light source 201R is made shortest.

The output terminal part 604 of the control circuit 60 is disposed in the upper portion of the first section as with the DMD 40. Meanwhile, the LED drive circuit 70 is disposed in the lower portion of the second section as with the three light sources 201R, 201G, and 201B.

In this embodiment, the high-power LED light sources are driven by pulse width modulation, and the LED drive circuit 70 performs modulation with relatively high current values. Accordingly, EMI noise is prone to occur at the output terminal parts 701R, 701G, and 701B and the cables 203R, 203G, and 203B. If the EMI noise is superimposed on DMD drive signals transferred from the output terminal part 604 of the control circuit 60 to the cable 401, the DMD 40 may be driven in an unstable manner, thereby resulting in deteriorated image quality of projection images.

In this embodiment, the output terminal part 604 of the control circuit 60 is disposed at the upper position of the endmost portion of the first section, and the LED drive circuit 70 is disposed in the lower portion of the second section. That is, the two components are disposed in two-dimensionally diagonal positions on the bottom surface of the main body cabinet 10. In addition, the two components are also disposed in three-dimensionally diagonal positions in an inner space of the main body cabinet 10. Accordingly, in this embodiment, the output terminal part 609 of the control circuit 60 can be separated from the LED drive circuit 70 as much as possible. That is, EMI noise generated at the LED drive circuit 70 is less prone to be superimposed on DMD drive signals output from the output terminal part 604 to the DMD 40. Therefore, it is possible to suppress deterioration of image quality due to the EMI noise.

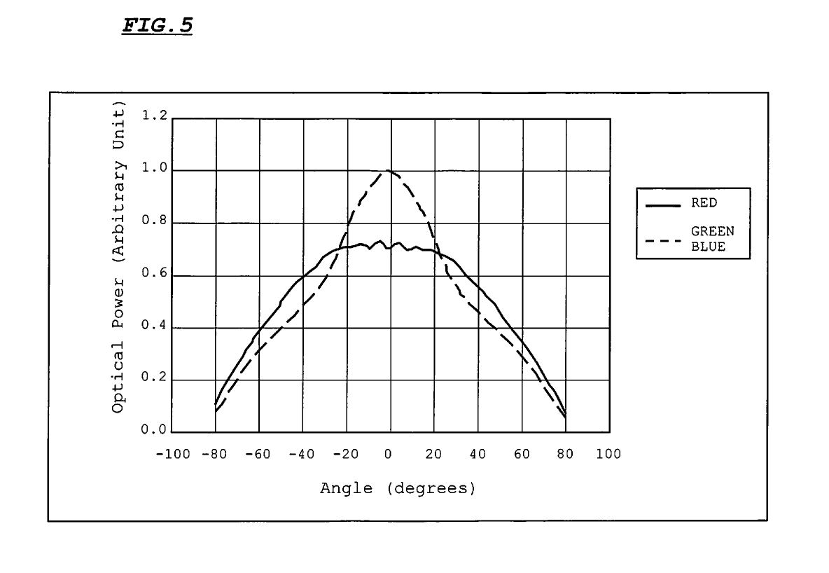

FIG. 5 is a diagram showing light-emission characteristics of a red light source 201R, a green light source 201G, and a blue light source 201B. In FIG. 5, a solid line indicates the characteristics of the red light source 201R, and a broken line indicates the characteristics of the green light source 201G and the blue light source 201B. The horizontal axis of the graph indicates a divergence angle and the vertical axis indicates strength of the lights.

As shown in FIG. 5, the red light source 201R has a larger light spread angle than those of the other two light sources 201G and 201B. Accordingly, light from the red light source 201R is hard to take into the lenses, which causes large loss at the light-guiding optical system 30. Accordingly, it is necessary to set a larger drive current for the red light source 201R than those for the other two light sources 201G and 201B. Therefore, larger EMI noise is prone to occur at the red light source cable 203R through which such a larger drive current flows.

In this embodiment, the red light source 201R is disposed nearest the LED drive circuit 70, and among the three cables 203R, 203G, and 203B, the cable 203R for the red light source 201R is made shortest. This allows reduction of EMI noise at the cable 203R at which largest EMI noise is apt to occur. Therefore, it is possible to reduce EMI noise at the cable 203R, 203G, and 203B on the whole.

Further, in this embodiment, the projection optical unit 50 is formed by the lens unit 501 and the curved mirror 502 provided on an output surface of the lens unit 501. Accordingly, the projection optical unit 50 is longer in the front-back direction and is disposed ranging from the first to fourth sections. Therefore, if the light source system 20 is disposed at a side of the lens unit 501, a wide space can be easily produced at a side of the curved mirror 502, that is, in the second section. The DMD 40 is disposed on an incident surface of the lens unit 501, and generally, the output terminal part 604 is disposed near the DMD 90. Accordingly, the output terminal part 604 is disposed in the endmost portion of the first section. Therefore, by disposing the LED drive circuit 70 in the second section, the LED drive circuit 70 can be smoothly disposed in a diagonal position with respect to the output terminal part 604.

### Modification Example 1

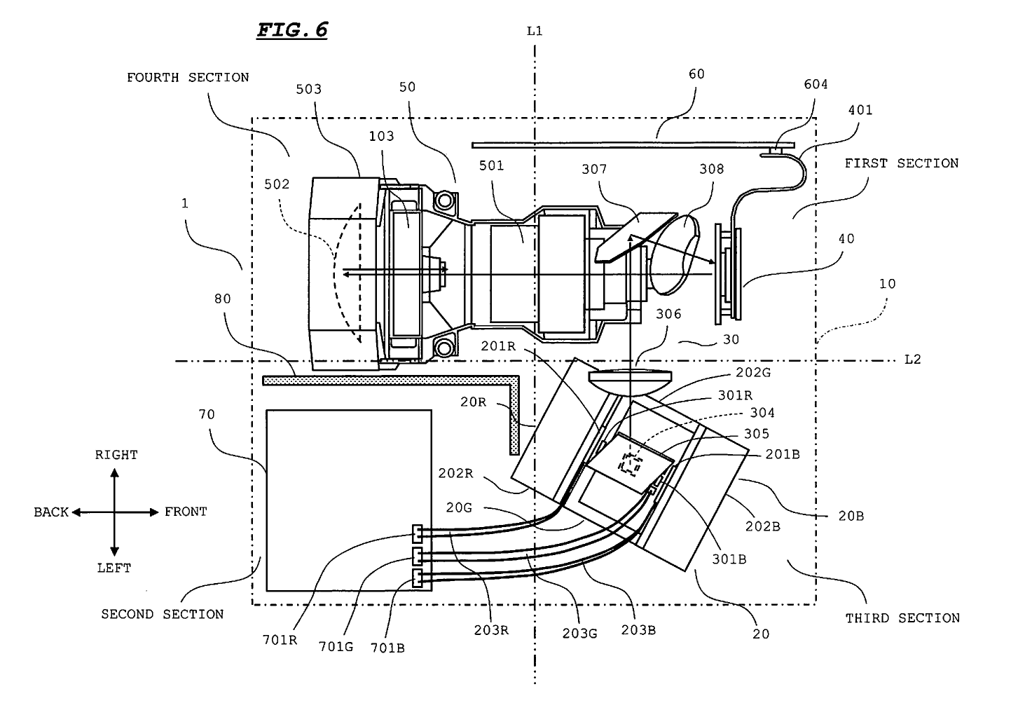

FIG. 6 is a diagram (plane view) showing a configuration of a projector in a modification example 1.

In the projector in this embodiment, an electromagnetic shield part 80 for blocking out electromagnetic waves is disposed between the LED drive circuit 70 and the output terminal part 604 of the control circuit 60. The electromagnetic shield part 80 is formed by a sheet-like shield material made from ferrite or amorphous metal, or by a shield material made from a mesh resin sheet coated with silver. By attaching such a sheet-like shield material to a plate member, the electromagnetic shield part 80 can be disposed between the LED drive circuit 70 and the output terminal part 604. Alternatively, such a sheet-like shield material may be attached to a side surface of the housing 503 of the projection optical unit 50 or a side surface of a housing (not shown) holding the constituents of the light-guiding optical system 30.

In such an arrangement, EMI noise traveling from the LED drive circuit 70 toward the output terminal part 604 can be blocked out. Accordingly, it is possible to further suppress superimposition of EMI noise on DMD drive signals output from the output terminal part 604.

### Modification Example 2

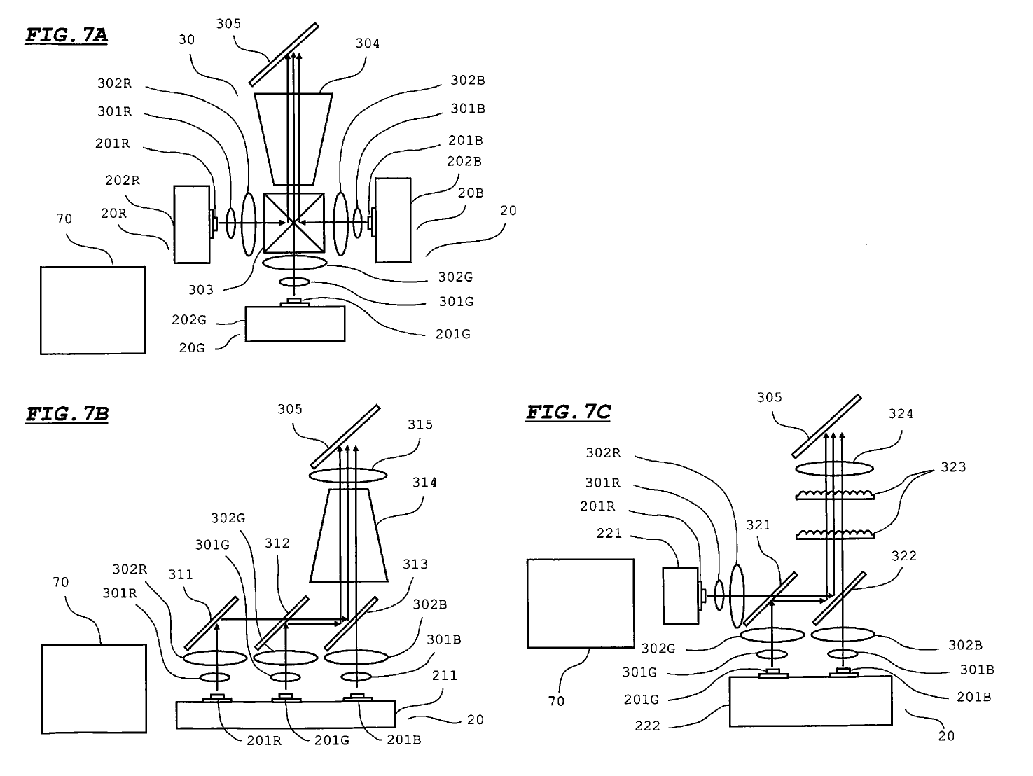

FIGS. 7A to 7C are diagrams for describing a configuration of the light source system 20 and the light-guiding optical system 30 in a modification example 2: FIG. 7A is a schematic partial view of the light source system 20 and the light-guiding optical system 30 in the foregoing embodiment; and FIGS. 7B and 7C are schematic partial view of the light source system 20 and the light-guiding optical system 30 in the modification example 2. FIGS. 7A to 7C also show schematically an LED drive circuit 70 for describing positional relationships among the light sources 201R, 201G, and 201B and the LED drive circuit 70.

The configurations of the light source system 20 and the light-guiding optical system 30 shown in FIGS. 7B and 7C can be used in place of the configuration of the same in the foregoing embodiment shown in FIG. 7A.

In the light source system 20 shown in FIG. 7B, the red light source 201R, the red light source 201G, and the blue light source 201B are disposed on one plane of one heat sink 211 at predetermined intervals. In addition, the light-guiding optical system 30 includes a mirror 311, two dichroic mirrors 312 and 313, a hollow rod 314, and a relay lens 315, in place of the dichroic prism 303 and the hollow rod 304 shown in FIG. 7A.

The dichroic mirror 312 allows R light to pass through and reflects G light. The dichoic mirror 313 allows B light to pass through and reflects R light and G light. The hollow rod 314 is tapered so as to become smaller in cross-section area from the incident end surface toward the output end surface.

The R light emitted from the red light source 201R is converted to a parallel light by the first lens 301R and the second lens 302R, and then is reflected by the mirror 311. The R light passes through the dichroic mirror 312, and is reflected by the dichroic mirror 313, and then enters the hollow rod 314.

The G light emitted from the green light source 201G is converted to a parallel light by the first lens 301 and the second lens 302G, and is reflected by the dichroic mirror 312. The G light is then reflected by the dichroic mirror 313, and enters the hollow rod 314.

The B light emitted from the blue light source 201B is converted to a parallel light by the first lens 301B and the second lens 302B, passes through the dichroic mirror 313, and then enters the hollow rod 314.

The R light, G light, and B light are unified in illuminance distribution by the action of the hollow rod 314 at an output end surface thereof. The R light, G light, and B light emitted from the hollow rod 314 pass through the relay lens 315 and travel toward the mirror 305. Subsequently, the R light, G light, and B light are guided to the DMD 40 in the same manner as that in the foregoing embodiment.

Next, in the light source system 20 shown in FIG. 7C, the red light source 201R is disposed on one plane of a heat sink 221, and the green light source 201G and the blue light source 201B are disposed on one plane of a heat sink 222 with a specific space therebetween. The red light source 201R is oriented almost vertical to the green light source 201G and the blue light source 201B. In addition, the light-guiding optical system 30 includes two dichroic mirrors 321 and 322, a fly-eye lens 323, and a condenser lens 324, in place of the dichroic prism 303 and the hollow rod 304 shown in FIG. 7A. The dichroic mirror 321 allows R light to pass through and reflects G light. The dichroic mirror 322 allows B light to pass through and reflects R light and G light. The fly-eye lens 323 is formed by a pair of lenses, each of which is formed by a large number of lens cells arranged in a fly-eye pattern.

The R light emitted from the red light source 201R is converted to a parallel light by the first lens 301R and the second lens 302R, and then passes through the dichroic mirror 321. The R light is then reflected by the dichroic mirror 322 and then enters the fly-eye lens 323.

The G light emitted from the green light source 201G is converted to a parallel light by the first lens 301G and the second lens 302G, and is reflected by the dichroic mirror 321. The G light is then reflected by the dichroic mirror 322, and enters the fly-eye lens 323.

The B light emitted from the blue light source 201B is converted to a parallel light by the first lens 301B and the second lens 302B, passes through the dichroic mirror 322, and then enters the fly-eye lens 323.

The R light, G light, and B light are divided by the lens cells of the fly-eye lens 323, and the divided lights are superimposed on the DMD 40 by the condenser lens 324. Accordingly, the R light, G light, and B light irradiated to the DMD 40 are unified in illuminance distribution.

The R light, G light, and B light emitted from the condenser lens 324 travel to the mirror 305, and are guided to the DMD 40 in the same manner as that in the foregoing embodiment.

In the arrangements of FIGS. 7B and 7C, the red light source 201R is also disposed nearest the LED drive circuit 70. Accordingly, it is possible to reduce EMI noise generated at the cable 203R (not shown in FIGS. 7A to 7C) as in the foregoing embodiment.

In the arrangement of FIG. 7A, in place of the hollow rod 304, the hollow rod 314 and the relay lens 315 shown in FIG. 7B can be used, or the fly-eye lens 323 and the condenser lens 324 shown in FIG. 7C can be used. In addition, in the arrangement of FIG. 7B, in place of the hollow rod 314 and the relay lens 315, the hollow rod 304 shown in FIG. 7A can be used, or the fly-eye lens 323 and the condenser lens 324 shown in FIG. 7C can be used. Further, in the arrangement of FIG. 7C, in place of the fly-eye lens 323 and the condenser lens 324, the hollow rod 304 shown in FIG. 7A and the hollow rod 314 and the relay lens 315 shown in FIG. 7B can be used.

In addition, as an integrator, a glass rod integrator (solid rod integrator) can be used in place of the hollow rod. Further, the light sources 201R, 201G, and 201B can be cooled down by using cooling jackets with coolant, in place of heat sinks.

### Others

Although an embodiment of the present invention is as described above, the present invention is not limited to this embodiment. In addition, the embodiment of the present invention can further be modified in various manners besides the foregoing ones.

For example, LED light sources are used as light sources 201R, 201G, and 201B in the foregoing embodiment. Alternatively, laser light sources may be used instead.

In addition, the light sources 201R, 201G, and 201B are driven by pulse width modulation (PWM) in the foregoing embodiment. Alternatively, the light sources 201R, 201G, and 201B are not limited to this, and may be driven by pulse amplitude waveform modulation (PAM).

Further, in the foregoing embodiment, the output terminal part 604 of the control circuit 60 is disposed on the upper portion of the main body cabinet 10, and the LED drive circuit 70 is disposed in the lower portion of the main body cabinet 10, whereby the output terminal part 604 and the LED drive circuit 70 are disposed in three-dimensionally diagonal positions in the inner space of the main body cabinet 10. However, they may be made identical in height, and the two components are only needed to be disposed in two-dimensionally diagonal position on the bottom surface (the placement plane) of the main body cabinet 10. As a matter of course, it is possible to provide a longest distance between the two components by disposing them in three-dimensionally diagonal positions. Accordingly, they are desirably disposed in three-dimensionally diagonal positions unless there is no restriction on disposition.

Besides, the embodiment of the present invention can be appropriately modified in various manners, within the scope of technical ideas recited in the claims.

What is claimed is:

1. A projection display device, comprising:
a light source;
an imager which modulates light from the light source;
a light-guiding optical part which guides the light from the light source to the imager;
a projection optical part which enlarges and projects the light modulated by the imager;
a light source drive part which drives the light source by pulse modulation;
an imager drive part which drives the imager; and
an output part which outputs a drive signal generated by the imager drive part to the imager, wherein
the output part is disposed in a first section within a main body cabinet, and the light source drive part is disposed in a second section arranged diagonally to the first section.

2. The projection display device according to claim 1, wherein
a plurality of the light sources are provided, and
among the plurality of light sources, a light source with a largest drive current is disposed nearest the light source drive part.

3. The projection display device according to claim 2, wherein
the plurality of light sources include a red light source emitting light of red wavelength band, a green light source emitting light of green wavelength band, and a blue light source emitting light of blue wavelength band, and
among the plurality of light sources, the red light source is disposed nearest the light source drive part.

4. The projection display device according to claim 1, wherein
a shield part which blocks out electromagnetic waves is provided between the output part and the light source drive part.

5. The projection display device according to claim 1, wherein
the projection optical part includes a lens unit and a curved mirror provided on an output surface of the lens unit, and
the light source drive part is disposed on a side of the curved mirror.
